(19) United States
(12) Patent Application Publication
(10) Pub. No.: US 2003/0040321 A1
(43) Pub. Date: Feb. 27, 2003

(54) Method for communication apparatus in utilizing global positioning system to proceed time switch

(75) Inventors: Kun-Huei Chen, Taipei Hsieng (TW); Yung-Feng Wang, Taipei Hsieng (TW)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsieng (TW)

(21) Appl. No.: 09/934,711

(22) Filed: Aug. 23, 2001

(51) Int. Cl. H04Q 7/20

(52) U.S. Cl. 455/456; 455/418; 455/566

(57) ABSTRACT

The invention is a method for communication apparatus in utilizing global positioning system to proceed time switch, wherein a global positioning system and a communication apparatus are integrated as a whole, and in one memory of said communication apparatus preset with a database of various time zone worldwide including a comparison table of the time differences between each said time zone and the longitude and latitude coordinates covered by each said time zone, and said communication apparatus utilizes said global positioning system to judge the longitude and latitude coordinates of residence and location, and utilize said comparison table according to the longitude and latitude coordinates of residence and location for searching the corresponding time differences therebetween, and renew the preset time to local time according to said time differences.

### FIELD OF THE INVENTION

The invention relates to a time switch method utilized in a communication apparatus, more particularly to a method for a communication apparatus in utilizing a global positioning system to proceed with time switch therein.

### PRIOR ART

During recent years, due to vigorous development in communication industry, the price for mobile phone is getting cheaper and cheaper, further resulting in more and more people using mobile phone. Moreover, design and development of mobile phone not only forges toward market tendency, light, thin and small, but also plans for function and purpose of which to further satisfy with requirement for public consumer, and constantly enhances, such as preset a time setting software in the mobile phone, in which equips with a perpetual calendar, after the time (year, month, day, hour, minute) of the mobile phone is set, it can follow the perpetual calendar to proceed time operation, and the display device of the mobile phone can show the time, thus people can proceed instant communication between friends and business companion through the mobile phone, and utilize various functions of the mobile phone, therefore, the mobile phone provides with more various advantages than conventional telephone in simpler, quicker . . . etc.

However, the time setting software preset in the mobile phone is set according to the place where the user usually lives in and gets along (below called residence for short), while the user leaves residence to another country (below called location for short), to proceed mobile phone roaming, time of the mobile phone cannot automatically adjust to local time, which makes the user should often adjust time, and feel very inconvenient.

### SUMMARY OF THE INVENTION

In view of above description, to improve the defects of conventional communication apparatus, in which preset time must be adjusted according to local time while be used in various places, which makes great inconvenience and bother in employment. The inventor experiences enduring striving in research and experiments, finally develops to design one kind of the present invention, which integrates global positioning system and communication system of a communication apparatus. In one memory of the communication apparatus preset with comparison table of time zone data, after the time of the communication apparatus is set according to the time of residence, the coordinates of the communication apparatus can be determined through the global positioning system, and according to the coordinates to check on the comparison table the corresponding time differences between location and residence, and then according to the time differences to renew the preset time of the communication apparatus to local time.

### DESCRIPTION OF THE DRAWINGS

FIG. 1 is the flow chart of the present invention.

### DETAILED DESCRIPTION

Owing to nowadays science and technology age of convenient traffic day by day, the sphere of activities for human gradually extend all over the world, therefore, how to make people precisely locate the location in the vast area, while communicate with people in other area for any time in any place, to rise efficiency, and to prevent meaningless waste on manpower, time, and resources, has become one urgent requirement for present society. To satisfy with the requirement, various apparatus equipped with global positioning system (below called GPS for short), global system for mobile communication (below called GSM for short) function come with the tide of fashion, and become one fundamental apparatus in daily life and on employment for many people.

The present invention is related to the method for communication apparatus in utilizing global positioning system to proceed time switch, which integrates GPS and communication system of communication apparatus, such as GSM, GPRS, CDMA, etc., and preset a database for time zone all over the world in one memory of the communication apparatus, the database includes one comparison table of each said time zone and the longitude and latitude coordinates covered by each said time zone, and after one central process unit (CPU) of the communication apparatus utilizes the GPS to judge the longitude and latitude coordinates of residence and location, CPU can utilize the said comparison table according to the longitude and latitude coordinates of residence and location, to search the corresponding time zone and time differences between residence and location from the comparison table, and further, renew the preset time to location time according to the said time differences, and show the time through one display device of the communication apparatus. Thus, through the CPU utilizing the GPS to identify various time zones, which makes the time of the communication apparatus automatically switch to local time following time zone crossed while users proceed roaming of communication apparatus.

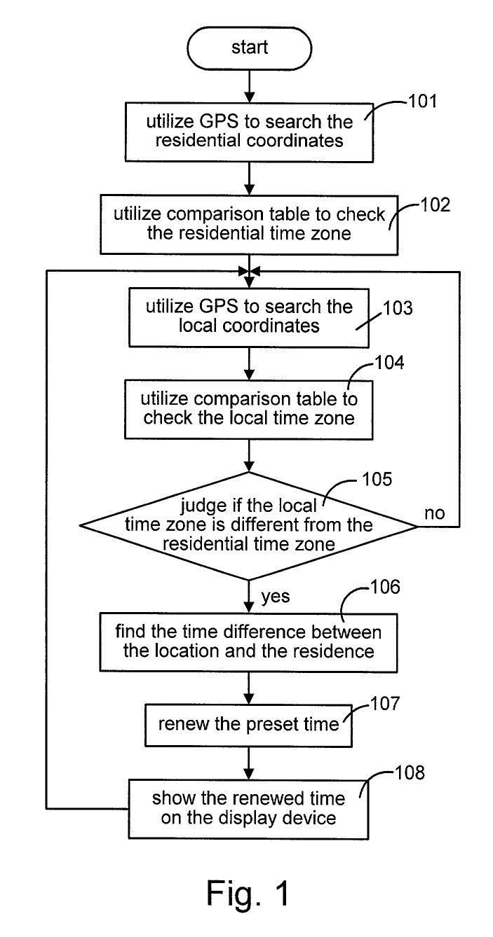

In one preferred embodiment of the invention, please referring to FIG. 1, while the time of the said communication apparatus is set according to residential time, the said CPU will proceed with dialing process following steps below:

(101) utilize the said GPS to search the residential coordinates of the communication apparatus;

(102) utilize the comparison table to search the corresponding time zone for the coordinates, and store the same in the said memory;

(103) utilize the GPS again to search the local coordinates of the communication apparatus;

(104) further utilize the comparison table to search the corresponding time zone for the local coordinates, and store the same in the memory;

(105) identify if the local time zone is different from the residential time zone;

(106) if it is, then utilize the comparison table again to check the time differences between the residence and the location;

(107) according to the time differences, renew the preset residential time to the local time;

(108) then show the renewed time through the display device, and proceed step (103);

When the CPU utilizes the comparison table to judge that the time zone of local coordinates is the same as the time zone of residential coordinates, then proceeds step (103).

From the above description, it is appreciated that when the communication apparatus moves from one time zone to another one, it can automatically proceed with time renewing instantly, and therefore it is unnecessary to repeatedly set the time of the communication apparatus due to different time zone.

In order to let the present invention be more understandable, an embodiment is detailedly described as follows:

If there is a Mr. Wu who resides in Taipei (residence), after his communication apparatus, such as mobile phone, is set according to residential time, while Mr. Wu visits his relatives in Japan (location), the GPS of the communication apparatus will search the local coordinates of the communication apparatus, and further, the communication apparatus will know from its comparison table that time differences between Taipei and Japan is one hour added, therefore, the display device of the communication apparatus will show the time which increase one hour than preset time.

In the present invention, the residence means the place where user usually lives in and gets along; the time preset and stored in the memory of communication apparatus is set according to the place where user usually lives in and gets along; the location means the place where user moves to with another time zone different from the residence.

Viewing from above-mentioned description, wherever the electronic communication apparatus is used, the preset time of the communication apparatus can switch instantly, and therefore it is unnecessary to repeatedly set the time of the communication apparatus due to be in different time zone.

1. A method for communication apparatus in utilizing global positioning system to proceed time switch, wherein a global positioning system and a communication apparatus are integrated, and in one memory of said communication apparatus preset with a database of various time zone all over the world, said database includes a comparison table of the time differences between each said time zone and the longitude and latitude coordinates covered by each said time zone, and after one CPU of said communication apparatus utilizes said global positioning system to judge the longitude and latitude coordinates of residence and location, the CPU can utilize said comparison table according to the longitude and latitude coordinates of residence and location, to search the corresponding time zone and time differences between residence and location from said comparison table, and further, renew the preset time to local time according to said time differences, and show said time through one display device of said communication apparatus.

2. The method for communication apparatus in utilizing global positioning system to proceed time switch according to claim 1, wherein after the time of said communication apparatus is set according to residential time, said CPU will proceed with dialing process following steps below:
utilizing said global positioning system to search the residential coordinates of the said communication apparatus;
utilizing said comparison table to search the corresponding time zone for the said coordinates, and store the residential time zone in the said memory;
utilizing said global positioning system again to search the location coordinates of said communication apparatus;
utilizing said comparison table to search the corresponding time zone for the local coordinates, and store the local time zone in said memory;
identifying if the local time zone is different from the residential time zone;
if it is, then utilizing said comparison table again to check the time differences between said residence and said location;
then renewing the preset residential time to the local time according to said time differences;
then show the renewed time through said display device.

3. The method for communication apparatus in utilizing global positioning system to proceed time switch according to claim 2, wherein when said CPU utilizes said comparison table to judge that the time zone of location coordinates is the same as the time zone of residential coordinates, said display device shows the local coordinates of said communication apparatus searched by said global positioning system.

4. The method for communication apparatus in utilizing global positioning system to proceed time switch according to claim 2, wherein after said display device shows the renewed time, then CPU again utilizes said global positioning system to search the local coordinates of said communication apparatus.
